(19) United States
(12) Patent Application Publication
(10) Pub. No.: US 2025/0377958 A1
(43) Pub. Date: Dec. 11, 2025

(54) COMPONENT ROTATION

(71) Applicant: INTERNATIONAL BUSINESS MACHINES CORPORATION, ARMONK, NY (US)

(72) Inventors: Andrew C. M. Hicks, Highland, NY (US); Patrick James Meaney, Poughkeepsie, NY (US); MICHAEL E GILDEIN, Wappingers Falls, NY (US); Christopher V DeRobertis, Hopewell Junction, NY (US); RYAN THOMAS RAWLINS, New Paltz, NY (US)

(21) Appl. No.: 18/738,115

(22) Filed: Jun. 10, 2024

(51) Int. Cl. G06F 11/00

(52) U.S. Cl. CPC G06F 11/008; G06F 11/2023

(57) ABSTRACT

Described is a method for monitoring and rotating electrical and/or mechanical components, the method includes receiving a set of metrics for a plurality of components and evaluating the set of metrics for the plurality of components. The method also includes determining to perform a component rotation for a first component from the plurality of components and performing a component rotation based on a component rotation plan, where the component rotation plan indicates the first component from the plurality of components is to be rotated with a second component from the plurality of components.

### BACKGROUND

This disclosure relates generally to component rotation, and in particular to extend a lifespan and performance of hardware through component rotation.

Electronic devices such as, Information technology (IT) equipment include various electrical and mechanical components, such as central processing units (CPUs), that typically have a lifespan of optimal usage prior to eventual failure. As an electrical and/or mechanical component ages, performance degrades, and the electrical and/or mechanical component often suffers from issues such as, an increase in energy consumption or a triggering of operational errors. Though enterprise systems utilizing IT equipment typically have redundancies and additional capacity available for critical failure events or usage demand based events, the redundant components are generally idle for extended time periods during instances of non-usage.

### SUMMARY

Embodiments in accordance with the present invention disclose a method, computer program product and computer system for component rotation, the method, computer program product and computer system can receive a set of metrics for a plurality of components. The method, computer program product and computer system can evaluate the set of metrics for the plurality of components. The method, computer program product and computer system can determine to perform a component rotation for a first component from the plurality of components. The method, computer program product and computer system can perform a component rotation based on a component rotation plan, wherein the component rotation plan indicates the first component from the plurality of components is to be rotated with a second component from the plurality of components.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a component rotation program for monitoring and rotating electrical and/or mechanical components, in accordance with an embodiment of the present invention.

FIG. 3A illustrates an example of a component rotation program for electrical and mechanical component monitoring and rotation, in accordance with an embodiment of the present invention.

FIG. 3B illustrates another example of a component rotation program for electrical and mechanical component monitoring and rotation, in accordance with an embodiment of the present invention.

### DETAILED DESCRIPTION

Embodiments of the present invention provide a component rotation program for monitoring and rotating electrical and/or mechanical components. Rotating components with alternate available components allows for the in-use components to experience reduced or no usage for a period of time, resulting in an increased effective lifespan of the system with the components as a whole. Embodiments of the present invention can utilize a time based trigger for performing a component rotation, where components are rotated based on a set schedule (e.g., client defined schedule). Embodiments of the present invention can also utilize an evaluation based trigger for performing a component rotation, where the evaluation is based on physical, environmental, performance, and/or instrumental data and metrics. The instrumental data and metrics can include humidity, temperature, voltage, current, and air pressure readings at the component and/or near the component utilizing various sensors.

Embodiments of the present invention can also utilize service metrics such as, mean time to failure (MTTF) and predicted maintenance schedule when evaluating the physical, environmental, performance, and/or instrumental data and metrics for all of the components. While performing the evaluation, embodiments of the present invention proactively predict the degradation of components. For problematic components (e.g., performance degradation, system errors), embodiments of the present invention establish a component rotation plan that can exclude or reduce utilization of the problematic components until those components are serviced or replaced. The component rotation can be a physical rotation or a usage rotation through a signal system on the device or between client sites (e.g., a first disaster recovery site and a second disaster recovery site).

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

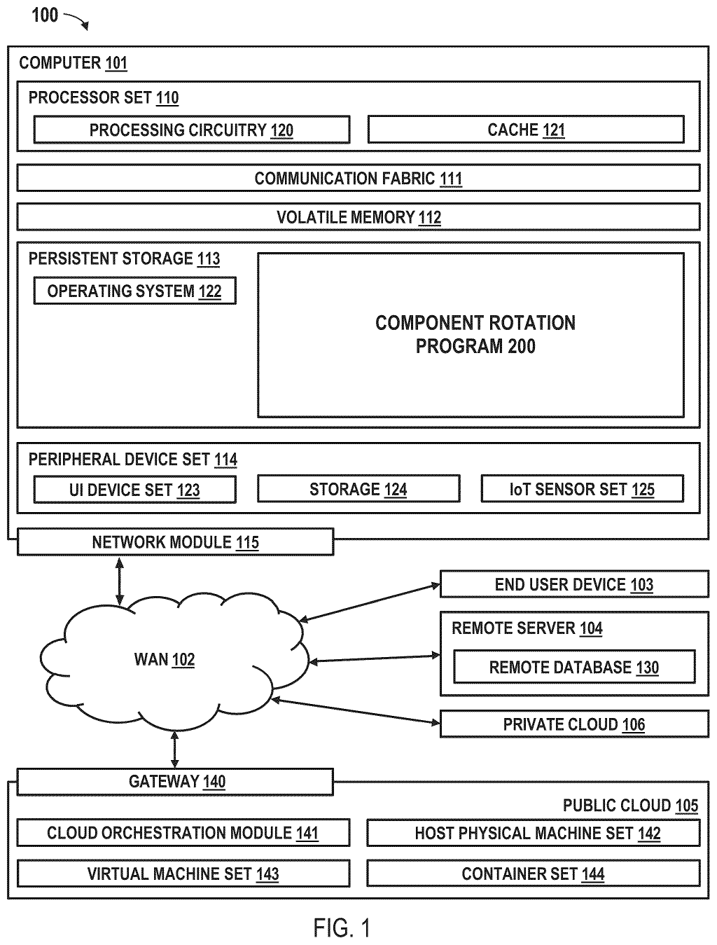

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, component rotation program 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing. In other computing environments, processor set 110 may be designed for performing one or more artificial intelligence (AI) decisions and/or operations.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

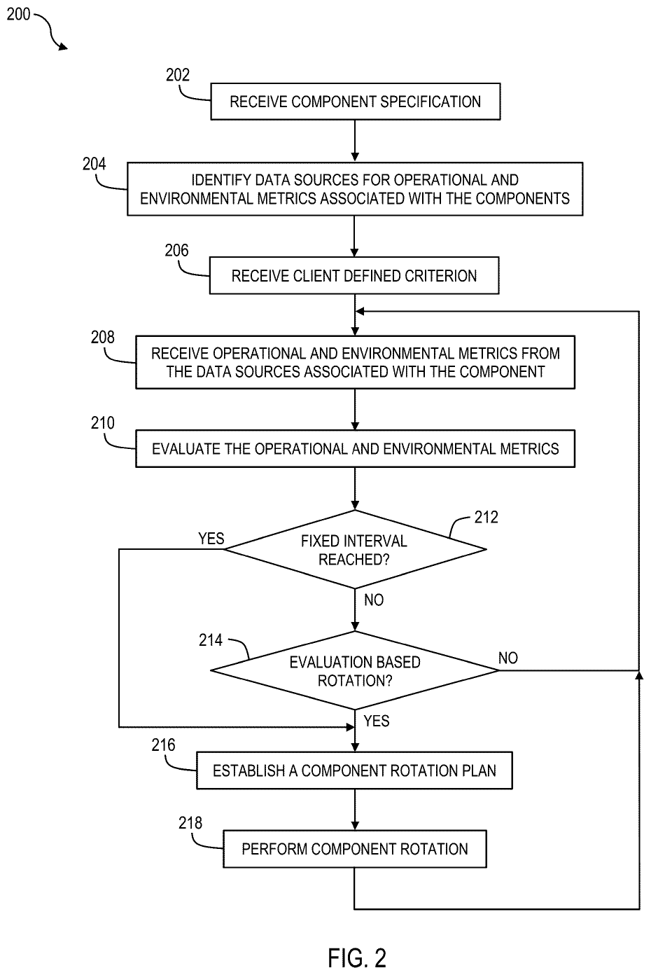

FIG. 2 depicts a flowchart of a component rotation program for monitoring and rotating electrical and/or mechanical components, in accordance with an embodiment of the present invention.

For a general overview, to monitor and rotate electrical and/or mechanical components, embodiments of component rotation program 200 can receive component specification for each component, identify data sources (e.g., one or more sensors, incorporated component instrumentation) for operational and environment metrics associated with the components, and receive client defined criterion (e.g., defined schedule, workload limits) for rotating the components. Embodiments of component rotation program 200 can further receive operational and environmental metrics from the data sources associated with the component and evaluate the operational and environmental metrics to determine whether to perform a component rotation. Embodiments of component rotation program 200 can determine to perform the component rotation based on a fixed interval being reached or based on the results of an evaluation of the operational and environmental metrics for the component. Embodiments of component rotation program 200 can establish a component rotation plan based on the fixed interval being reached or based on the results from the evaluation, and perform the component rotation based on the established component rotation plan.

Component rotation program 200 receives component specification (202). For a device containing electrical and/or mechanical components that component rotation program 200 is to monitor and rotate, component rotation program 200 receives component specification for each of the electrical and/or mechanical components. The component specification for each of the components can include various operational metrics, along with environmental metrics. The component specification represents baseline data to which component rotation program 200 can perform an evaluation when receiving operational metrics and environment metrics during normal operations of the components. In one embodiment, component rotation program 200 receives component specification for each electrical and mechanical component installed on information technology (IT) equipment at a client site. Component rotation program 200 receives component specification for 20 CPUs installed on the IT equipment, where one portion of the CPUs have one set of operational metrics, and another portion of the CPUs have a second set of operational metrics. The component specification also includes environmental metrics, for example, operational temperature ranges for each of the 20 CPUs installed on the device, where a first operational temperature range for operations under normal loads is 40° C.-80° C. and a second operational temperature range for operations under high loads is 60° C.-90° C.

Component rotation program 200 identifies data sources for operational and environmental metrics associated with the components (204). For operational metrics, component rotation program 200 identifies the components as being the data sources, where the components include instrumentation that provide current operational data. Current operational data can include voltage values, current values, CPU usage, CPU time usage, cooling fan speed, cooling fan time usage, and any other operational metric that affects a lifespan of the electrical and/or mechanical component. For environmental metrics, component rotation program 200 identifies the components as being the data sources and/or one or more sensors present on or near the device with the components. The electrical and/or mechanical components, and/or the one or more sensors can capture environmental data that includes temperature, humidity, pressure, air quality, electromagnetic fields (EMF) fields, and any other data values for environmental conditions that affect a lifespan of the component.

Component rotation program 200 receives client defined criterion (206). In one embodiment, the client defined criterion allows for a user to define a schedule for component rotation. The defined schedule for the component rotation plan can include a specified interval during which component rotation program 200 is to not perform a component rotation such as, during instances of high utilization or load. Alternatively, the defined schedule for the component rotation plan can include a specified interval during which component rotation program 200 is to perform a component rotation such as, during instances of low utilization or load. The specified interval can be based on a time interval such as, a weekday between the hours of 8 am and 6 pm. In another embodiment, component rotation program 200 receives a client defined criterion that includes limitations for the component rotation plan. The limitations for the component rotation plan can include a specified operational metric, where the specified operation metric represents one or more data values that are not to be exceeded by one or more corresponding data values from current operational metrics. In one example, the specified operation metric is a specified CPU utilization rate of 15%, where component rotation program 200 is to not perform a component rotation for CPUs that are operating above a specified utilization rate (i.e., x>15%). If the CPU is operating at a high utilization rate (e.g., 50%), component rotation program 200 determines, based on the client defined criterion, to not perform a component rotation for the CPU with the high utilization rate until the current utilization rate drops below the specified utilization rate.

Component rotation program 200 receives operational and environmental metrics from the data sources associated with the component (208). As previously discussed, a component can represent the data source that includes instrumentation that provides current operational metrics (i.e., data) to component rotation program 200. Current operational data can include voltage values, current values, CPU usage, CPU time usage, cooling fan speed, cooling fan time usage, and any other operational metric that affects a lifespan of the electrical and/or mechanical component. In one embodiment, component rotation program 200 receives operational metrics for 20 CPUs present on a device, where the operational metrics includes CPU usage as a percentage value and CPU usage as a time value. Also as previously discussed, the component and/or one or more sensors present on the device with the component can represent the data sources that provide the environmental metrics. Electrical and/or mechanical components, and/or the one or more sensors can capture environmental data that includes temperature, humidity, pressure, air quality, electromagnetic fields (EMF) fields, and any other data values for environmental conditions that affects a lifespan of the electrical and/or mechanical component. In one embodiment, component rotation program 200 receives environmental metrics from a plurality of sensors monitoring the component and/or the device, where the plurality of sensors includes a temperature sensor, a humidity sensor, and a pressure sensor. Component rotation program 200 can continuously receive data from the plurality of sensors representing the environmental metrics or can receive the data in set intervals (e.g., hourly).

Component rotation program 200 evaluates the operational and environmental metrics (210). Component rotation program 200 can evaluate the operational and environmental metrics by analyzing the received operational and environmental metrics from (208) with respect to the received component specification, the client defined criterion, and/or any other base rules defined in component rotation program 200. In some embodiments, component rotation program 200 can utilize AI and machine learning (ML) to evaluate the operational and environmental metrics when making component rotation decisions. From a previously discussed embodiment where component rotation program 200 receives operational metrics for 20 CPUs present on a device that includes CPU usage as a percentage value and CPU usage as a time value, component rotation program 200 evaluates the operational metrics with respect to the received component specification and the client defined criterion. The received CPU usage as percentage values for 5 out of the 20 CPUs is over 50%, 10 out of the 20 CPUs is under 20%, and a remaining 5 out of the 20 CPUs are 0% (i.e., idle). The received CPU usage as time values indicate that the 5 out of 20 CPUs are operating at over 50% usage values for x1 number of hours, the 10 out of 20 CPUs are operating at 20% usage values for x2 number of hours, and the 5 out of 20 CPUs are operating at over 0% usage values for x3 number of hours. Component rotation program 200 evaluates the operational and environmental metrics and determines that the x1 number of hours exceeds a client defined criterion of a number of hours for a CPU with a usage of over 50%. Additionally, component rotation program 200 evaluates the operational and environmental metrics and determines that 3 of the 5 CPUs that are idle are scheduled for faulty and scheduled for replacement. Therefore, the 3 of the 5 CPUs that are idle are not available for component rotation when component rotation program 200 establish a component rotation plan.

In another embodiment, component rotation program 200 evaluates the operational and environmental metrics for multiple sets of CPUs across multiple locations. During the evaluation, component rotation program 200 determines that a first set of CPUs operating at a first location are experiencing CPU usage rates above 60% in high temperature (e.g., 85° C.) and low pressure conditions for a predetermined amount of time (e.g., x1 number of hours). Component rotation program 200 also determines that a second set of CPUs operating at a second location are idle in low temperature and high pressure conditions. For the first location, component rotation program 200 determines during the evaluation that the first set of CPUs have exceeded base rules defined in component rotation program 200 for CPUs operating over a predetermined amount of time in particular environmental conditions (e.g., 75° C.) at a particular CPU usage percentage value (e.g., 50%). Component rotation program 200 can utilize an algorithm that applies a weight, based on a component type (e.g., electrical, mechanical) and component characteristic (e.g., sensitivity to environmental conditions), to each of the various operational and environmental metrics during the evaluation of the operational and environmental metrics.

In some embodiments, component rotation program 200 can utilize a risk formula for determining a likelihood of a component failure. An example of general risk formula (A) is provided below:

$$R = a ( factor a ) + b ( factor b ) + … n ( factor n ) \qquad ( A )$$

For general risk formula (A), R represents an overall relative risk of failure of a component, where the component is currently active (i.e., in service) and component rotation program 200 receives operational and environmental metrics from the data sources associated with the active component. Coefficient a and b respectively represent risk values (+or −) for factor a and factor b, where factor a and factor b each represent a different type of metric value (e.g., temperature value and usage time) that component rotation program 200 receives in (208). Coefficient n represents the n^{th} risk value (e.g., 8^{th}) for factor n, representing the nth different type of metric value. Utilizing the general risk formula (A) during the evaluation, component rotation program 200 can select components for rotation by identifying a component with a low R value to replace another component with a high R value and establish a component rotation plan based on the results of general risk formula (A) for each of the components.

Component rotation program 200 determines whether a fixed interval is reached (decision 212). The fixed interval represents a set amount of time that triggers a component rotation. The fixed interval is provided by the received component specification, the client defined criterion, and/or any other base rules defined in component rotation program 200. In the event component rotation program 200 determines a fixed interval is not reached (“no” branch, decision 212), component rotation program 200 determines whether an evaluation based rotation (decision 214). In the event component rotation program 200 determines a fixed interval is reached (“yes” branch, decision 212), component rotation program 200 establishes a component rotation plan (216).

Component rotation program 200 determines whether to perform an evaluation based rotation (decision 214). In the event component rotation program 200 determines to perform an evaluation based rotation (“yes” branch, decision 214), component rotation program 200 establishes a component rotation plan (216). In the event component rotation program 200 determines to not perform an evaluation based rotation (“no” branch, decision 214), component rotation program 200 reverts to receiving new operational and environmental metrics from the data sources associated with the component (208).

Component rotation program 200 establishes a component rotation plan (216). In this embodiment, component rotation program 200 establishes the component rotation plan by identifying one or more available components to perform the rotation based on the evaluation of the operational and environmental metrics for all the components. In one embodiment, based on the evaluation of the operational and environmental metrics, component rotation program 200 determines that a first CPU that was operating at a first CPU usage rate of 60% requires rotation and identifies a second CPU that was operating at a second CPU usage rate of 5% for an equivalent amount of CPU usage time as the first CPU, as a component to perform the rotation with. Therefore, component rotation program 200 establishes the component rotation plan of transitioning the processing from the first CPU to the second CPU. In another embodiment, based on the evaluation of the operational and environmental metrics, component rotation program 200 identifies a second CPU and a third CPU to perform the rotation with, where component rotation program 200 establishes the component rotation plan of transitioning the processing from the first CPU to the second CPU and the third CPU. In another embodiment, based on the evaluation of the operational and environmental metrics, component rotation program 200 establishes a component rotation plan that includes transitioning from a first set of CPUs at a first client site to a second set of CPUs a second client site.

In some embodiments, component rotation program 200 establishes a component rotation plan that includes generating a work order, where in the work order identifies a first component that is to be rotated with a second component based on the evaluation of the operational and the environmental metrics. For example, a device is utilizing ten cooling fans in a first configuration and based on an evaluation that component rotation program 200 performs, component rotation program 200 determines a voltage value for two of the cooling fans is lower than a voltage value for the remaining eight cooling fans. The variation in the lower voltage can indicate additional wear and resistance that the cooling fan motors are experiencing with the first configuration, where the two cooling fans are encountering a greater number of dust particles (i.e., a lower air quality level). Component rotation program 200 establishes a component rotation plan that includes changing the positions of the two cooling fans with the lower voltage values with the positions of two cooling fans from the eight cooling fans with the higher voltage values. The changing of the positions of the cooling fans provides the second configuration. Therefore, the work order that component rotation program 200 generates includes the current first configuration and the new second configuration which includes the component rotation.

Component rotation program 200 performs a component rotation (218). Component rotation program 200 performs a component rotation based on the established component rotation plan. From a previously discussed embodiment, where component rotation program 200 determines that a first CPU that was operating at a first CPU usage rate of 60% requires rotation with a second CPU that was operating at a second CPU usage rate of 5% for an equivalent amount of CPU usage time as the first CPU, component rotation program 200 performs the component rotation between the first CPU and the second CPU. Component rotation program 200 performs the component rotations by transitioning the processing from the first CPU to the second CPU via a signal system. From another previously discussed embodiment, where component rotation program 200 identifies a second CPU and a third CPU to perform the rotation with, component rotation program 200 performs the component rotation by transitioning the processing from the first CPU to the second CPU and the third CPU via the signal system. From yet another previously discussed embodiment, component rotation program 200 performs a component rotation based on the established component rotation plan that includes transitioning from a first set of CPUs at a first client site to a second set of CPUs a second client site. From yet another previously discussed embodiment, where component rotation program 200 generates a work order that includes the current first configuration and the new second configuration which includes the component rotation, component rotation program 200 performs the component rotation by sending the work order to a device associated with the client and/or a repair technician.

In alternative embodiments, component rotation program 200 can monitor, on a first component, operational and environmental metrics. For example, component rotation program 200 can continuously monitor operational and environmental metrics in real-time and track defined data values and statistics of the monitored operational and environmental metrics over time, and store historical trigger event data that is utilized by component rotation program 200 to detect a data anomaly. Component rotation program 200 can detect a data anomaly based on the operational and environmental metrics and can trigger, based on the data anomaly, a failover of a workload on the first component onto the second component (i.e., component rotation) to isolate distress in the first component.

Component rotation program 200 can monitor, on the secondary component, the operational and environmental metrics, based on the failover of the workload. For example, the operational and environmental metrics monitored on the second component can include the similar data values and statistics monitored on the first component, and triggered metrics or all metrics which may occur for a set period of time, such as a client specified time window. Component rotation program 200 can compare the monitored operational and environmental metrics of the first component and the second component to determine whether the data anomaly was caused by an environmental characteristic (e.g., temperature) or a physical characteristic (e.g., degradation) of the first component.

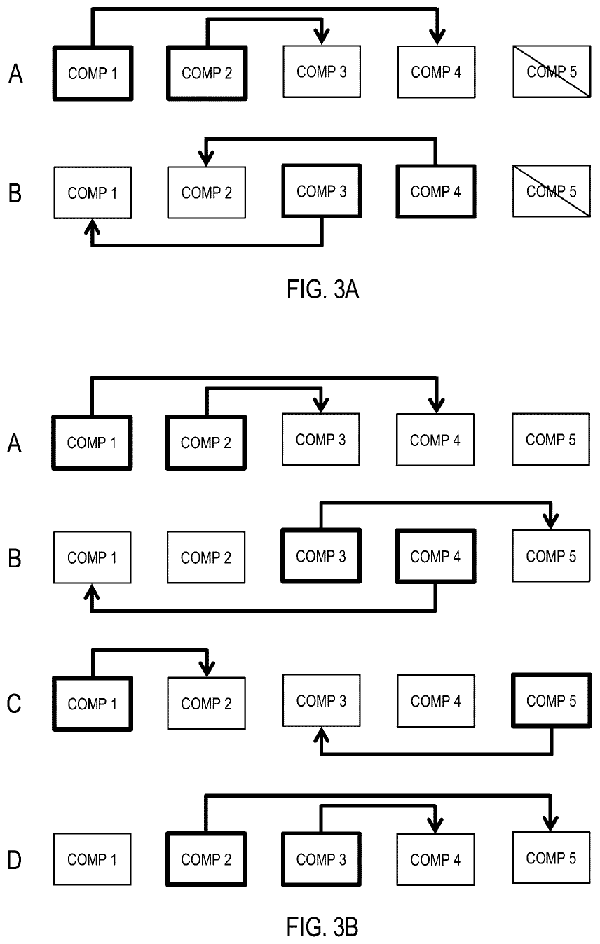

FIG. 3A illustrates an example of a component rotation program for electrical and mechanical component monitoring and rotation, in accordance with an embodiment of the present invention. In this example, component 1 (i.e., comp 1) and component 2 (i.e., comp 2) are performing operations, component 3 (i.e., comp 3) and component 4 (i.e., comp 4) are idle, and component 5 (i.e., comp 5) is out of service due to required repairs. Component rotation program 200 receives operational and environmental metrics from the data sources associated with components 1-4 and evaluates the operational and environmental metrics. Based on the evaluation of the operational and environment metrics, component rotation program 200 determines to perform an evaluation based rotation for component 1 and 2 based on a utilization rate exceeding a utilization rate threshold for a predetermined amount of time. Component rotation program 200 establishes a component rotation plan that includes a first transition of component 1 to component 4 and a second transition of component 2 to component 3, as illustrated by rotation plan A in FIG. 3A. Based on the established component rotation plan A, component rotation program 200 performs the component rotation. A transition as discussed herein can refer to an electronic transition and/or a physical transition. An electronic transition can include moving workloads, jobs, and/or any other activities performed on one physical component to another physical component. A physical transition includes a physical replacement of a first component with a second component.

In one embodiment component rotation program 200 utilizes a risk formula for determining a likelihood of a component failure such as, previously discussed general risk formula (A). Since component 5 is out of service due to required repairs, component rotation program 200 does not determine an R value for component 5. In this example, since component 1 is being rotated with component 4, component rotation program 200 identifies component 4 as having a lower R value when compared to component 1 having a higher R value. Similarly, since component 2 is being rotated with component 3, component rotation program 200 identifies component 3 as having a lower R value when compared to component 2 having a higher R value.

As component 3 and component 4 now perform operations, components 1 and component 2 are idle, and component 5 remains out of service due to the required repairs. Component rotation program 200 continuously receives operational and environmental metrics from the data sources associated with components 1-4 and evaluates the operational and environmental metrics. Based on the evaluation of the operational and environment metrics, component rotation program 200 determines to perform an evaluation based rotation for component 3 and 4 based on a scheduled interval rather than based on a utilization rate exceeding a utilization rate threshold for a predetermined amount of time, as previously discussed. Component rotation program 200 establishes a component rotation plan that includes a second transition of component 3 to component 1 and a second transition of component 4 to component 2, as illustrated by rotation plan B in FIG. 3A. Based on the established component rotation plan B, component rotation program 200 performs the component rotation. In another embodiment, component rotation program 200 establishes a component rotation plan that includes a transition of component 4 back to component 1 and component 3 back to component 2. Component rotation program 200 can continue rotating back and forth between the two components depending on the established component rotation plan.

In some embodiments, component rotation program 200 has the ability to utilize a randomization algorithm when establishing a component rotation plan to perform a random selection of a replacement component (e.g., component 1 for component 3) from available components (i.e., component 1 and 2) to perform the component rotation with. In another embodiment, component rotation program 200 considers any previously established component rotation plans when establishes a current component rotation plan. To avoid component rotation program 200 rotating between two components back and forth, component rotation program 200 can cycle through all available components to perform the component rotation. For example, to avoid component rotation program 200 rotating between two components back and forth (e.g., component 1 to component 3, component 3 to component 1), component rotation program 200 cycles through all available components to perform the component rotation (e.g., component 1 to component 3, component 3 to component 2, component to component 4, and so on).

FIG. 3B illustrates another example of a component rotation program for electrical and mechanical component monitoring and rotation, in accordance with an embodiment of the present invention. In this example, component 1 (i.e., comp 1) and component 2 (i.e., comp 2) are performing operations and component 3 (i.e., comp 3), component 4 (i.e., comp 4), and component 5 (i.e., comp 5) are idle. Component rotation program 200 receives operational and environmental metrics from the data sources associated with components 1-5 and evaluates the operational and environmental metrics. Based on the evaluation of the operational and environment metrics, component rotation program 200 determines to perform an evaluation based rotation for component 1 and 2 based on a utilization rate exceeding a utilization rate threshold for a predetermined amount of time. Component rotation program 200 establishes a component rotation plan that includes a first transition of component 1 to component 4 and a second transition of component 2 to component 3, as illustrated by rotation plan A in FIG. 3B. Based on the established component rotation plan A, component rotation program 200 performs the component rotation.

As component 3 and component 4 now perform operations, components 1, 2, and 5 component 2 are idle. Component rotation program 200 continuously receives operational and environmental metrics from the data sources associated with components 1-5 and evaluates the operational and environmental metrics. Based on the evaluation of the operational and environment metrics, component rotation program 200 determines to perform an evaluation based rotation for component 3 and 4. Component rotation program 200 establishes a component rotation plan that includes a second transition of component 3 to component 5 and a second transition of component 4 to component 1, as illustrated by rotation plan B in FIG. 3B. Based on the established component rotation plan B, component rotation program 200 performs the component rotation. In this embodiment, each component rotation plan that component rotation program 200 establishes includes the next available component and therefore, component rotation plan C and component rotation plan D that component rotation program 200 establish continue that cycle of rotating between the next available component.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving a set of metrics for a plurality of components;
evaluating the set of metrics for the plurality of components;
determining to perform a component rotation for a first component from the plurality of components; and
performing the component rotation based on a component rotation plan, wherein the component rotation plan indicates the first component from the plurality of components is to be rotated with a second component from the plurality of components.

2. The computer-implemented method of claim 1, wherein determining to perform the component rotation for the first component from the plurality of components, further comprises:
determining a fixed interval is reached, wherein the fixed interval represents a set amount of time to trigger the component rotation; and
establishing the component rotation plan based on results from the evaluating of the set of metrics for the plurality of components.

3. The computer-implemented method of claim 1, further comprising:
establishing the component rotation plan based on results from the evaluating of the set of metrics for the plurality of components.

4. The method of claim 1, wherein the set of metrics is selected from a group consisting of operational metrics or environmental metrics.

5. The computer-implemented method of claim 1, further comprising:
receiving component specification for each component from the plurality of components; and
identifying one or more data sources for providing the set of metrics for the plurality of components.

6. The computer-implemented method of claim 1, wherein performing the component rotation based on the component rotation plan increases an effective lifespan of a system with the plurality of components.

7. The computer-implemented method of claim 1, wherein performing the component rotation based on the component rotation plan further comprises:
triggering a failover of a workload of the first component onto the second component based on a detection of a data anomaly in the set of metrics for the plurality of components;
monitoring the set of metrics for the second component based on the failover of the workload; and
comparing the set of metrics of the first component and the second component to determine whether the data anomaly was caused by an environmental characteristic or a physical characteristic of the first component.

8. A computer program product comprising:
one or more computer-readable storage media;
program instructions, stored on at least one of the one or more storage media, to receive a set of metrics for a plurality of components;
program instructions, stored on at least one of the one or more storage media, to evaluate the set of metrics for the plurality of components;
program instructions, stored on at least one of the one or more storage media, to determine to perform a component rotation for a first component from the plurality of components; and
program instructions, stored on at least one of the one or more storage media, to perform the component rotation based on a component rotation plan, wherein the component rotation plan indicates the first component from the plurality of components is to be rotated with a second component from the plurality of components.

9. The computer program product of claim 8, wherein program instructions, stored on at least one of the one or more storage media, to determine to perform the component rotation for the first component from the plurality of components, further comprises:
program instructions, stored on at least one of the one or more storage media, to determine a fixed interval is reached, wherein the fixed interval represents a set amount of time to trigger the component rotation; and
program instructions, stored on at least one of the one or more storage media, to establish the component rotation plan based on results from the evaluating of the set of metrics for the plurality of components.

10. The computer program product of claim 8, further comprising:
program instructions, stored on at least one of the one or more storage media, to establish the component rotation plan based on results from the evaluating of the set of metrics for the plurality of components.

11. The computer program product of claim 8, wherein the set of metrics is selected from a group consisting of operational metrics or environmental metrics.

12. The computer program product of claim 8, further comprising:
program instructions, stored on at least one of the one or more storage media, to receive component specification for each component from the plurality of components; and
program instructions, stored on at least one of the one or more storage media, to identify one or more data sources for providing the set of metrics for the plurality of components.

13. The computer program product of claim 8, wherein performing the component rotation based on the component rotation plan increases an effective lifespan of a system with the plurality of components.

14. The computer program product of claim 8, wherein program instructions, stored on at least one of the one or more storage media, to perform the component rotation based on the component rotation plan further comprises:
program instructions, stored on at least one of the one or more storage media, to trigger a failover of a workload of the first component onto the second component based on a detection of a data anomaly in the set of metrics for the plurality of components;
program instructions, stored on at least one of the one or more storage media, to monitor the set of metrics for the second component based on the failover of the workload; and
program instructions, stored on at least one of the one or more storage media, to compare the set of metrics of the first component and the second component to determine whether the data anomaly was caused by an environmental characteristic or a physical characteristic of the first component.

15. A computer system comprising:
one or more processors, one or more computer-readable memories and one or more computer-readable storage media;
program instructions, stored on at least one of the one or more storage media for execution by at least one of the one or more processors via at least one of the one or more memories, to receive a set of metrics for a plurality of components;
program instructions, stored on at least one of the one or more storage media for execution by at least one of the one or more processors via at least one of the one or more memories, to evaluate the set of metrics for the plurality of components;
program instructions, stored on at least one of the one or more storage media for execution by at least one of the one or more processors via at least one of the one or more memories, to determine to perform a component rotation for a first component from the plurality of components; and
program instructions, stored on at least one of the one or more storage media for execution by at least one of the one or more processors via at least one of the one or more memories, to perform the component rotation based on a component rotation plan, wherein the component rotation plan indicates the first component from the plurality of components is to be rotated with a second component from the plurality of components.

16. The computer system of claim 15, wherein program instructions, stored on at least one of the one or more storage media for execution by at least one of the one or more processors via at least one of the one or more memories, to determine to perform the component rotation for the first component from the plurality of components, further comprises:
program instructions, stored on at least one of the one or more storage media for execution by at least one of the one or more processors via at least one of the one or more memories, to determine a fixed interval is reached, wherein the fixed interval represents a set amount of time to trigger the component rotation; and
program instructions, stored on at least one of the one or more storage media for execution by at least one of the one or more processors via at least one of the one or more memories, to establish the component rotation plan based on results from the evaluating of the set of metrics for the plurality of components.

17. The computer system of claim 15, further comprising:
program instructions, stored on at least one of the one or more storage media for execution by at least one of the one or more processors via at least one of the one or more memories, to establish the component rotation plan based on results from the evaluating of the set of metrics for the plurality of components.

18. The computer system of claim 15, wherein the set of metrics is selected from a group consisting of operational metrics or environmental metrics.

19. The computer system of claim 15, further comprising:
program instructions, stored on at least one of the one or more storage media for execution by at least one of the one or more processors via at least one of the one or more memories, to receive component specification for each component from the plurality of components; and
program instructions, stored on at least one of the one or more storage media for execution by at least one of the one or more processors via at least one of the one or more memories, to identify one or more data sources for providing the set of metrics for the plurality of components.

20. The computer system of claim 15, wherein performing the component rotation based on the component rotation plan increases an effective lifespan of a system with the plurality of components.
